(19) United States
(12) Patent Application Publication
(10) Pub. No.: US 2009/0222161 A1
(43) Pub. Date: Sep. 3, 2009

(54) SYSTEM AND METHOD FOR ARRANGING VEHICLE REPAIR SERVICE

(75) Inventors: SHU-JEN TSAI, Tu-Cheng (TW); WEN-HAW TSENG, Tu-Cheng (TW); SHIH-FANG WONG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/353,929

(22) Filed: Jan. 14, 2009

(30) Foreign Application Priority Data
Feb. 29, 2008 (CN) 200810300436.7

(51) Int. Cl. G06F 19/00; G01S 1/00

(52) U.S. Cl. 701/30; 342/357.09; 342/357.08

(57) ABSTRACT

An exemplary vehicle management system for arranging vehicle repair service includes a management center and a vehicle. The management center includes a center processor associated with a center transceiver and a center database. The vehicle includes a vehicle processor associated with a GPS receiver and a vehicle transceiver. The GPS receiver receives satellite signals to be processed by the vehicle processor to generate corresponding position data of the vehicle. When the vehicle is determined to need repair service, the vehicle processor signals the vehicle transceiver to transmit the position data to the center transceiver of the management center. The center processor selects a repair station for providing vehicle repair service based on a criterion including the position data of the vehicle and the position data of the repair stations.

### BACKGROUND

1. Technical Field

The present disclosure relates to vehicle management systems and methods, and more particularly to a vehicle management system and method for arranging vehicle repair service.

2. Description of Related Art

Generally, a global positioning system (GPS) receiver is capable of receiving satellite signals from a plurality of GPS satellites, and triangulating the received satellite signals to obtain a calculated position of the GPS receiver.

One application of the GPS is cargo monitoring. GPS receivers are installed in cargo vehicles for providing real-time position information of the vehicles to a management center. Then, the management center can estimate the times that the cargos will be delivered to their respective destinations. In some situations, a vehicle may have an accident or break down on the road. When this happens, the vehicle may not be able to deliver the cargo before the vehicle is repaired.

Therefore, it is desired to provide a vehicle management system and method for overcoming the above-described shortcomings.

### BRIEF DESCRIPTION OF THE DRAWINGS

FIG. 1 is a schematic diagram of a vehicle management system in accordance with an exemplary embodiment of the present invention.

FIG. 2 is a detailed block diagram of the vehicle management system of FIG. 1, in accordance with an exemplary embodiment of the present invention.

FIG. 3 is a flow chart illustrating a method for arranging vehicle repair service in accordance with an exemplary embodiment of the present invention.

### DETAILED DESCRIPTION

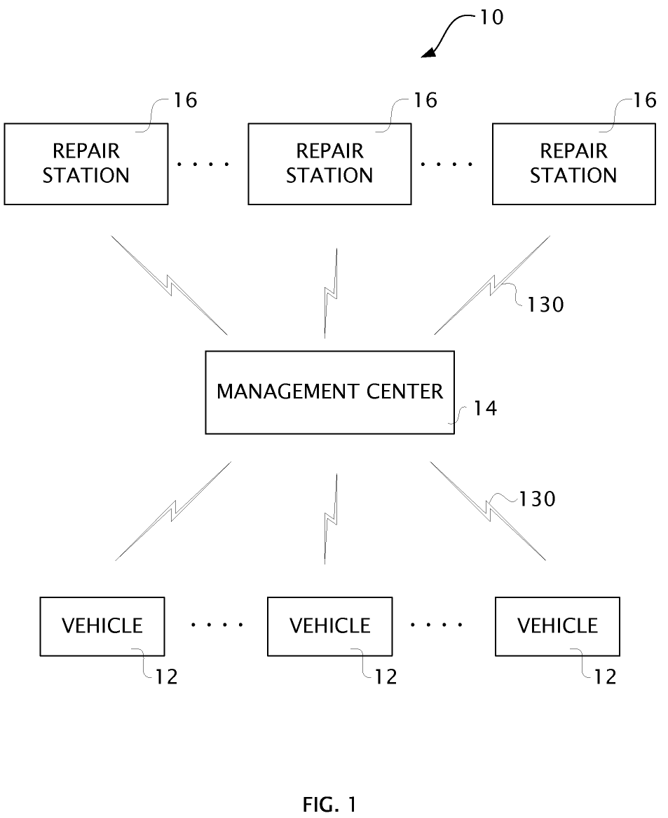

Referring to FIG. 1, a vehicle management system 10 in accordance with an exemplary embodiment is illustrated. The vehicle management system 10 includes a plurality of vehicles 12, a management center 14, and a plurality of repair stations 16. The plurality of vehicles 12, the management center 14, and the plurality of repair stations 16 are capable of communicating with each other via a communication network 130, for example, a Global System for Mobile communications (GSM) network or a Code Division Multiple Access (CDMA) network. The management center 14 may select a vehicle 12 to deliver cargo to a destination, and monitor a real-time status of the vehicle 12. The management center 14 may also store updatable service data available from the plurality of repair stations 16 via the communication network 130. The service data includes, but is not limited to, types of services available (scope of service), service charge, etc. As used in the description of embodiments herein, “repair” is not restricted to the meaning of fixing a broken element so that it works again. “Repair” can be interpreted to further comprise other meanings, such as “replace,” “substitute,” etc. For example, “repair” can include taking a malfunctioning, worn out, or inoperative part out from the vehicle 12, and replacing such part with a new part.

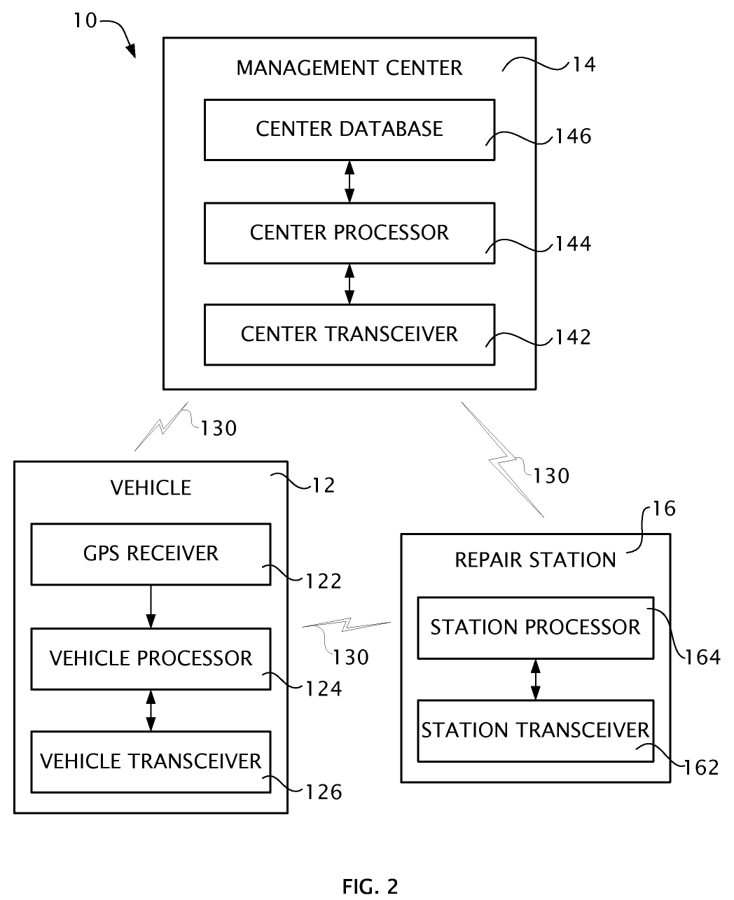

Referring to FIG. 2, a detailed block diagram of the vehicle management system 10 is illustrated. To conveniently describe the exemplary embodiment, one vehicle 12 and one repair station 16 associated with the management center 14 will be detailed hereinafter.

The vehicle 12 includes a GPS receiver 122, a vehicle processor 124, and a vehicle transceiver 126. The GPS receiver 122 receives satellite signals, and calculates a physical position of the vehicle 12 based on the satellite signals to generate corresponding position signals. The physical position includes a latitude coordinate and a longitude coordinate. The GPS receiver 122 transmits the position signals to the vehicle processor 124. The vehicle processor 124 processes the position signals to thereby generate corresponding position data, and signals the vehicle transceiver 126 to transmit the position data to the management center 14.

In some situations, the vehicle 12 may have crashed or broken down in the middle of the road. One or several parts, such as the brake or the engine of the vehicle 12, may no longer be functioning. In this situation, the malfunctioning vehicle 12 needs repair service arranged by the management center 14. The vehicle 12 having the problem can be hereinafter referred to as a “malfunctioning vehicle 12.”

The particular problems of the malfunctioning vehicle 12 can be determined by a self-checking process or by a manually aided process. The self-checking process can be implemented by periodically collecting or gathering diagnostic data transmitted from internal sensors (not shown) of the vehicle 12. The internal sensors are attached to various parts of the vehicle 12.

The manually aided process typically involves the driver of the malfunctioning vehicle 12 examining the malfunctioning vehicle 12 for defects. The driver can thus collect or gather diagnostic data, and manually input the diagnostic data to the vehicle processor 124. In other embodiments, the vehicle processor 124 collects or gathers diagnostic data of the malfunctioning vehicle 12 via both internal sensors and manual input. In the exemplary situation described herein, the “diagnostic data” includes information that one or several parts, such as the brake or the engine, of the malfunctioning vehicle 12 are in need of repair or replacement.

When the diagnostic data is gathered or collected, the vehicle processor 124 may combine the diagnostic data and the position data together to generate a data package, and signal the vehicle transceiver 126 to transmit the data package to the management center 14 via the communication network 130.

The management center 14 includes a center transceiver 142, a center processor 144, and a center database 146. The center transceiver 142 receives the data package transmitted from the vehicle transceiver 126, and transmits the data package to the center processor 144. The center processor 144 extracts the position data from the received data package to determine the exact location of the malfunctioning vehicle 12, and extracts the diagnostic data to determine the part(s) of the malfunctioning vehicle 12 which needs to be repaired or replaced. The center processor 144 selects a repair station 16 which can provide the necessary services to the malfunctioning vehicle 12, according to the position data and the service data stored in the center database 146. When the center processor 144 selects a repair station 16 which can provide the necessary services, the selection is based on at least two criteria detailed below.

The first criterion, which may be assigned with a higher priority, is whether the repair station 16 is the one located nearest to the malfunctioning vehicle 12. The first criterion involves comparing the position data of the malfunctioning vehicle 12 with the position data of the repair stations 16. The position data of the repair stations 16 are stored in the center database 146 of the management center 14. It should be noted that when the position of the repair stations 16 has been changed, the position data stored in the center database 146 can be updated to reflect this change.

When there are two or more repair stations 16 located nearest to the malfunctioning vehicle 12 by performing the first criterion, a second criterion can be further performed to select the appropriate repair station 16 which can provide the necessary service. The second criterion may be assigned with a lower priority than the first criterion. The second criterion involves comparing the diagnostic data of the malfunctioning vehicle 12 with the service data available of the repair stations 16. The service data may include service charge data which can be used to select the repair station 16. For example, there may be three repair stations 16 located nearest to the malfunctioning vehicle 12 and capable of providing required service. The center processor 144 can further compare the service charge of the three repair stations to select one of them with a lowest service charge.

The repair station 16 satisfying the first condition or both of the first and second conditions described above, as the case may be, is hereinafter referred to as a “selected station 16.” Once the selected station 16 is determined, the center processor 144 signals the center transceiver 142 to transmit a request message to the selected station 16 via the communication network 130.

The selected station 16 includes a station transceiver 162 and a station processor 164. The station transceiver 162 receives the request message transmitted from the center transceiver 142, and transmits the request message to the station processor 164. If the selected station 16 is available to provide the repair service, the station processor 164 signals the station transceiver 162 to transmit a confirmation response message to the management center 14. If the selected station 16 cannot provide the repair service, the station processor 164 signals the station transceiver 162 to transmit a rejection response message to the management center 14. In this latter case, the management center 14 selects another repair station 16 that is available to provide the repair service, based on the two conditions described above. This process is repeated as many times as is necessary until a repair station 16 that is available to provide the repair service is found.

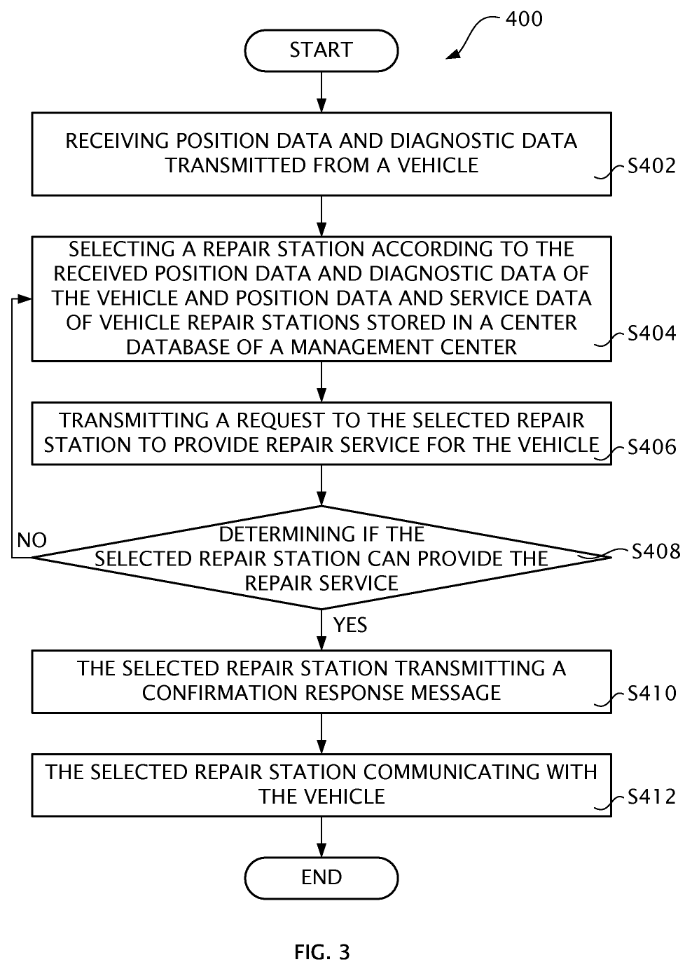

Referring to FIG. 3, a flow chart illustrating a method 400 for arranging vehicle repair service is shown. The method 400 includes the following blocks.

At block S402, the center transceiver 122 of the management center 12 receives position data and diagnostic data transmitted from the vehicle transceiver 126 of the malfunctioning vehicle 12.

At block S404, the center processor 144 of the management center 14 selects a repair station 16 by comparing the received position data and the diagnostic data of the malfunctioning vehicle 12 with the position data and the service data of the repair stations 16 stored in the center database 142 of the management center 12. The repair station 16 selected can of course provide the needed repair service. Furthermore, the repair station 16 selected can be the one which is located nearest to the malfunctioning vehicle 14, and which can provide a lowest service charge.

At block S406, the center transceiver 142 of the management center 14 transmits a request message to the station transceiver 162 of the selected station 16. The request message includes position information and diagnostic information of the malfunctioning vehicle 14.

At block S408, the station processor 164 determines if repair service can be provided based on the received request message. If the selected station 16 cannot provide the repair service, the procedure returns to block S404. If the selected station 16 can provide the repair service, the procedure goes to block S410.

At block S410, the selected station 16 transmits a confirmation response message to the management center 14. In particular, the station processor 163 signals the station transceiver 162 to transmit the confirmation response message to the center transceiver 142 via the communication network 130.

At block S412, the selected station 16 communicates with the malfunctioning vehicle 14 via the communication network 130 in order to provide the repair service.

As described above, the vehicle management system 10 can receive position information and diagnostic information of the malfunctioning vehicle 12 via the communication network 130. The vehicle management system 10 also can select the nearest repair station 16, and request the nearest repair station 16 to provide the repair service via the communication network 130. Thus the malfunctioning vehicle 14 can be promptly repaired. This service provided to the malfunctioning vehicle 14 can be particularly helpful when the malfunctioning vehicle 14 is in unfamiliar territory.

It should be noted that the various blocks in the method 400 illustrated in FIG. 3 may be performed in the order presented, or may be performed in a different order.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A vehicle management system for arranging vehicle repair service, the vehicle management system comprising:
a management center comprising a center processor, a center transceiver, and a center database, the center processor associated with the center transceiver and the center database, the center database comprising position data of repair stations; and
a vehicle comprising a vehicle processor, a global positioning system receiver, and a vehicle transceiver, the vehicle processor associated with the global positioning system receiver and the vehicle transceiver, the global positioning system receiver capable of receiving satellite signals and generating corresponding position signals, and the vehicle processor configured for processing the position signals to thereby generate position data of the vehicle;
wherein when the vehicle is determined to need repair service, the vehicle processor is capable of signaling the vehicle transceiver to transmit the position data of the vehicle to the center transceiver of the management center, and the center processor is configured for selecting one of the repair stations to provide vehicle repair service based on a first criterion comprising the position data of the vehicle and the position data of the repair stations.

2. The vehicle management system according to claim 1, wherein the center processor is configured for selecting the repair station nearest to the vehicle.

3. The vehicle management system according to claim 1, wherein the center database further comprises service data of the repair stations, the service data includes what repair services each of the repair stations can perform, the vehicle processor is further configured for collecting diagnostic data of the vehicle, and combining the diagnostic data with the position data to generate a data package, the vehicle transceiver is configured for transmitting the data package to the center transceiver of the management center, and the center processor is further configured for extracting the diagnostic data from the data package, and selecting said one of the repair stations further based on a second criterion comprising the diagnostic data of the vehicle and the service data of the repair stations.

4. The vehicle management system according to claim 3, wherein the first criterion comprising the position data of the vehicle and the position data of the plurality of repair stations has a higher priority than the second criterion comprising the diagnostic data of the vehicle and the service data of the repair stations.

5. The vehicle management system according to claim 4, wherein the service data includes service charge data on each of the repair stations, and the center processor is further configured for selecting the repair station capable of providing the lowest service charge, which is calculated by comparing the service charge data of the repair stations.

6. The vehicle management system according to claim 3, wherein the vehicle transceiver transmits the data package to the center transceiver of the management center via a communication network.

7. The management center according to claim 6, wherein the communication network is a Global System for Mobile communications (GSM) network.

8. The management center according to claim 6, wherein the communication network is a Code Division Multiple Access (CDMA) network.

9. A management center for arranging vehicle repair service to be provided to a vehicle, the management center comprising:
a center processor;
a center database storing position data of a plurality of repair stations and service data on services available from each of the repair stations; and
a center transceiver;
wherein the center transceiver is capable of receiving position data and diagnostic data transmitted from the vehicle, and the center processor is configured for selecting one of the plurality of repair stations to assist the vehicle based on at least one of the following first criterion and second criterion: the first criterion being a comparison of the position data of the vehicle with the position data of the plurality of repair stations, and the second criterion being a comparison of the diagnostic data of the vehicle and the service data of the plurality of repair stations.

10. The management center according to claim 9, wherein the vehicle comprises a global positioning system receiver, the global positioning system receiver is configured for receiving satellite signals and generating corresponding position signals, and the center processor is further configured for processing the position signals to thereby generate the position data of the vehicle.

11. The management center according to claim 9, wherein the center processor is further configured for selecting the repair station nearest to the vehicle.

12. The management center according to claim 9, wherein the first criterion comprising the comparison of the position data of the vehicle with the position data of the plurality of repair stations has a higher priority than the second criterion comprising the comparison of the diagnostic data of the vehicle and the service data of the plurality of repair stations.

13. The management center according to claim 12, wherein the service data includes service charge data available from each of the repair stations, and the center processor is further configured for selecting the repair station capable of providing the lowest service charge, which is calculated by comparing the service charge data of the repair stations.

14. The management center according to claim 9, wherein the vehicle processor is further configured for combining the position data and diagnostic data to generate a data package, and the vehicle transceiver is further configured for transmitting the data package to the center transceiver of the management center via a communication network.

15. A method for arranging vehicle repair service to be provided to a vehicle, the method comprising:
receiving position data and diagnostic data transmitted from a vehicle transceiver of the vehicle;
retrieving position data and service data of a plurality of repair stations, the position data and service data being stored in a center database of a management center;
comparing the received position data of the vehicle with the retrieved position data of the plurality of repair stations to generate a first comparison result;
comparing the diagnostic data of the vehicle with the retrieved service data of the plurality of repair stations to generate a second comparison result; and
selecting one of the repair stations according to the first comparison result and the second comparison result.

16. The method according to claim 15, wherein the selecting of one of the repair stations according to the first comparison result and the second comparison result comprises selecting the repair station which is nearest to the vehicle.

17. The method according to claim 15, wherein the comparing of the received position data of the vehicle with the retrieved position data of the plurality of repair stations to generate the first comparison result has a higher priority than the comparing of the diagnostic data of the vehicle with the retrieved service data of the plurality of repair stations to generate the second comparison result.

18. The method according to claim 15, further comprising:
transmitting the position data and the diagnostic data of the vehicle by a vehicle transceiver via a communication network to a center transceiver of the management center.

19. The method according to claim 15, further comprising:
combining the position data and the diagnostic data to generate a data package; and
transmitting the data package by the vehicle transceiver via the communication network to the center transceiver of the management center.

20. The method according to claim 15, further comprising:
transmitting a request message including the position data and the diagnostic data of the vehicle to a station transceiver of the selected repair station.
